(19) United States
(12) Patent Application Publication
(10) Pub. No.: US 2019/0031933 A1
(43) Pub. Date: Jan. 31, 2019

(54) REFRIGERATION CYCLE APPARATUS

(71) Applicant: Mitsubishi Electric Corporation, Tokyo (JP)

(72) Inventors: Takumi NISHIYAMA, Tokyo (JP); Kosuke TANAKA, Tokyo (JP)

(21) Appl. No.: 16/069,537

(22) PCT Filed: Feb. 22, 2016
(86) PCT No.: PCT/JP2016/055108

§ 371 Date: Jul. 12, 2018

(51) Int. Cl. C09K 5/04

(52) U.S. Cl. CPC C09K 5/045; C09K 2205/22; C09K 2205/126; C09K 2205/122

(57) ABSTRACT

A refrigeration cycle apparatus of the present invention includes a refrigeration circuit having a compressor, an outdoor heat exchanger, an indoor heat exchanger, and an expansion valve. Refrigerant is enclosed in the refrigeration circuit. The refrigerant contains three components: R32, R1234yf, and HFO1123. In a composition diagram in which a mass ratio between the three components is represented by triangular coordinates, the mass ratio between the three components falls in a range enclosed by: a first straight line connecting a point A to a point B; a second straight line connecting the point B to a point C; and a first curve connecting the point C to the point A. Each of all the three components has a mass ratio of more than 0% by mass.

### TECHNICAL FIELD

The present invention relates to a refrigeration cycle apparatus.

### BACKGROUND ART

Refrigerants having been used for air conditioner, refrigerator, and the like are those such as chlorofluorocarbon (CFC) and hydrochlorofluorocarbon (HCFC). Refrigerants containing chlorine such as CFC and HCFC, however, are currently restricted in use, because they have considerable influences on the ozone layer in the stratosphere (influences on global warming).

In view of this, hydrofluorocarbon (HFC) that is chlorine free and has low influence on the ozone layer has become used as refrigerant. As an example of such HFC, difluoromethane (also called methylene fluoride, Freon-32, HFC-32, R32, for example, referred to as “R32” hereinafter) is known (see Patent Document 1: Japanese Patent No. 3956589). Other known HFCs are tetrafluoroethane and R125 (1,1,1,2,2-pentafluoroethane), for example. In particular, R410A (a pseudo-azeotropic refrigerant mixture of R32 and R125) having a high refrigeration capacity is used widely.

It has, however, been pointed out that refrigerant such as R32 with a global warming potential (GWP) of 675 may be a cause of global warming. There has therefore been a demand for development of refrigerants having a still smaller GWP and low influence on the ozone layer.

As a refrigerant (working medium for heat cycle) having low influence on global warming and capable of achieving sufficient cycling performance for a heat cycle system, a refrigerant containing trifluoroethylene (also called 1,1,2-trifluoroethylene, HFO1123, for example, referred to as “HFO1123” hereinafter) having a GWP of about 0.3 is known (see for example Patent Document 2: WO2012/157764). HFO1123 containing carbon-carbon double bond that is easily decomposable by OH radicals in the atmosphere is therefore considered as having low influence on the ozone layer.

HFO1123, 2,3,3,3-tetrafluoroproene (also called 2,3,3,3-tetrafluoro-1-propene, HFO-1234yf, R1234yf, for example, referred to as “R1234yf” hereinafter) and refrigerant containing R32 are also known. Moreover, 1,3,3,3-tetrafluoro-1-propene (also called HFO-1234ze, R1234ze, for example, referred to as “R1234ze” hereinafter) is also known (see for example Patent Document 3: WO2015/115550).

### CITATION LIST

### Patent Document

### PTD 1: Japanese Patent No. 3956589

### PTD 2: WO2012/157764

### PTD 3: WO2015/115550

### SUMMARY OF INVENTION

### Technical Problem

HFO1123 used for the refrigerant disclosed in Patent Documents 2 and 3 is higher in working pressure than the conventionally-used R410A, R22, and R407C, for example. “Working pressure” is a pressure required for a refrigeration cycle (apparatus) to work. Among the conventional refrigerants such as R410A, R22, and R407C, R410A belongs to refrigerants with the highest working pressure.

In an existing refrigeration cycle apparatus using a conventional refrigerant, if the refrigerant is replaced with a refrigerant having a high content of HFO1123, the pressure for the apparatus to work has to be increased. While the existing refrigeration cycle apparatus has resistance to a pressure around the working pressure of R410A, the refrigeration cycle apparatus may not have resistance to a pressure higher than the working pressure of R410A, which results in a problem that the reliability of the refrigeration cycle apparatus is deteriorated particularly in terms of the resistance to pressure.

The composition range of the refrigerant disclosed in Patent Document 3 is set in consideration of the coefficient of performance and the refrigeration capacity (both are performance relative to 410A). Thus, Patent Document 3 does not take the working pressure into consideration. In particular, the composition range disclosed in Patent Document 3 includes a range that results in a higher working pressure than the working pressure of the conventional refrigerant.

The present invention has been made in view of the above problem, and aims to provide a refrigeration cycle apparatus having low influence on global warming and having sufficient reliability and sufficient performance.

### Solution to Problem

A refrigeration cycle apparatus according to the present invention includes a refrigeration circuit, and the refrigeration circuit includes a compressor, an outdoor heat exchanger, an indoor heat exchanger, and an expansion valve. Refrigerant is enclosed in the refrigeration circuit, and the refrigerant contains three components that are R32, R1234yf, and HFO1123. In a composition diagram in which a mass ratio between the three components is represented by triangular coordinates, the mass ratio between the three components falls in a range enclosed by: a first straight line connecting a point A to a point B, the point A representing 89% by mass of R32, 11% by mass of R1234yf, and 0% by mass of HFO1123, and the point B representing 51% by mass of R32, 49% by mass of R1234yf, and 0% by mass of HFO1123; a second straight line connecting the point B to a point C, the point C representing 51% by mass of R32, 27% by mass of R1234yf, and 22% by mass of HFO1123, a first curve connecting the point C to the point A and represented by a formula (1): y=0.0000268168x⁴−0.0021756190x³+0.0709089095x²−0.5115229095x−0.4473576993 . . . (1) where an x axis represents the component R1234yf, a y axis is perpendicular to the x axis, and a boundary condition is y≥0, y≤19.1. Each of all the three components has a mass ratio of more than 0% by mass.

A refrigeration cycle apparatus according to the present invention includes a refrigeration circuit, the refrigeration circuit including a compressor, an outdoor heat exchanger, an indoor heat exchanger, and an expansion valve. The refrigerant is enclosed in the refrigeration circuit, and the refrigerant contains three components that are R32, R1234ze, and HFO1123 In a composition diagram in which a mass ratio between the three components is represented by triangular coordinates, the mass ratio between the three components falls in a range enclosed by: a first straight line connecting a point A to a point B, the point A representing 94% by mass of R32, 6% by mass of R1234ze, and 0% by mass of HFO1123, and the point B representing 80% by mass of R32, 20% by mass of R1234ze, and 0% by mass of HFO1123; a second straight line connecting the point B to a point C, the point C representing 80% by mass of R32, 12% by mass of R1234ze, and 8% by mass of HFO1123; and a first curve connecting the point C to the point A and represented by a formula (2): y=0.0076x²+0.5253x−3.4259 . . . (2) where an x axis represents the component R1234ze, a y axis is perpendicular to the x axis, and a boundary condition is y≥0, y≤6.93. Each of all the three components has a mass ratio of more than 0% by mass.

A refrigeration cycle apparatus according to the present invention includes a refrigeration circuit, and the refrigeration circuit includes a compressor, an outdoor heat exchanger, an indoor heat exchanger, and an expansion valve. Refrigerant is enclosed in the refrigeration circuit, and the refrigerant contains three components that are R32, R1234yf, and HFO1123. In a composition diagram in which a mass ratio between the three components is represented by triangular coordinates, the mass ratio between the three components falls in a range enclosed by: a first straight line connecting a point B to a point C, the point B representing 0% by mass of R32, 100% by mass of R1234yf, and 0% by mass of HFO1123, the point C representing 0% by mass of R32, 57% by mass of R1234yf, and 43% by mass of HFO1123, a second straight line connecting the point B to a point A, the point A representing 31% by mass of R32, 69% by mass of R1234yf, and 0% by mass of HFO1123; and a curve connecting the point C to the point A and represented by a formula (3): y=−0.0002x³+0.0284x²−1.9477x+50.834 . . . (3) where an x axis represents the component HFO1123, a y axis is perpendicular to the x axis, and a boundary condition is y≥0, y≤26.7. Each of all the three components has a mass ratio of more than 0% by mass.

A refrigeration cycle apparatus according to the present invention includes a refrigeration circuit, and the refrigeration circuit includes a compressor, an outdoor heat exchanger, an indoor heat exchanger, and an expansion valve. Refrigerant is enclosed in the refrigeration circuit, and the refrigerant contains three components that are R32, R1234ze, and HFO1123 In a composition diagram in which a mass ratio between the three components is represented by triangular coordinates, the mass ratio between the three components falls in a range enclosed by: a first straight line connecting a point B to a point C, the point B representing 0% by mass of R32, 100% by mass of R1234ze, and 0% by mass of HFO1123, and the point C representing 0% by mass of R32, 52% by mass of R1234ze, and 48% by mass of HFO1123, a second straight line connecting the point B to a point A, the point A representing 41% by mass of R32, 59% by mass of R1234ze, and 0% by mass of HFO1123, and a curve connecting the point C to the point A and represented by a formula (4): y=2.16319E⁻⁰⁵x⁴−3.47400E⁻⁰³x³+2.21550E⁻⁰¹x²−7.61233E¹⁰⁰ x+1.24171E¹⁰² . . . (4) where an x axis represents the component HFO1123, a y axis is perpendicular to the x axis, and a boundary condition is y≥0, y≤35.3. Each of all the three components has a mass ratio of more than 0% by mass.

### Advantageous Effects of Invention

According to the present invention, a refrigeration cycle apparatus having low influence on global warming and having sufficient reliability and sufficient performance can be provided.

### BRIEF DESCRIPTION OF DRAWINGS

FIG. 1 is a schematic configuration diagram of a refrigeration cycle apparatus according to Embodiment 1.

FIG. 2 is a ternary composition diagram showing (R32/HFO1123/R1234yf) according to Embodiment 1.

FIG. 3 is a graph showing performance exhibited in a composition range of refrigerant according to Embodiment 1.

FIG. 4 is a ternary composition diagram showing a composition range (R32/HFO1123/R1234yf) of refrigerant according to a modification of Embodiment 1.

FIG. 5 is a graph showing performance exhibited in the composition range of the refrigerant according to the modification of Embodiment 1.

FIG. 6 is a ternary composition diagram showing a composition range (R32/HFO1123/R1234ze) of refrigerant according to Embodiment 2.

FIG. 7 is a graph showing performance exhibited in the composition range of the refrigerant according to Embodiment 2.

FIG. 8 is a ternary composition diagram showing a composition range (R32/HFO1123/R1234ze) of refrigerant according to a modification of Embodiment 2.

FIG. 9 is a graph showing performance exhibited in the composition range of the refrigerant according to the modification of Embodiment 2.

FIG. 10 is a ternary composition diagram showing a composition range (R32/HFO1123/R1234yf) of refrigerant according to Embodiment 3.

FIG. 11 is a graph showing performance exhibited in the composition range of the refrigerant according to Embodiment 3.

FIG. 12 is a ternary composition diagram showing a composition range (R32/HFO1123/R1234ze) of refrigerant according to Embodiment 4.

FIG. 13 is a graph showing performance exhibited in the composition range of the refrigerant according to Embodiment 4.

### DESCRIPTION OF EMBODIMENTS

In the following, embodiments of the present invention are described based on the drawings.

### Embodiment 1

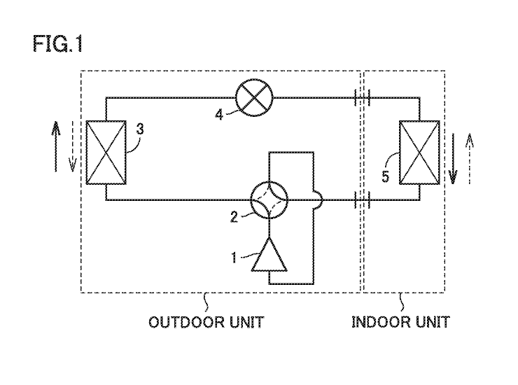

First, an overview of a refrigeration cycle apparatus in the present embodiment is described briefly. FIG. 1 is a schematic configuration diagram showing the refrigeration cycle apparatus according to Embodiment 1. The refrigeration cycle apparatus includes a refrigeration circuit, and the refrigeration circuit includes a compressor 1, a flow path switching valve 2 to switch the flow direction depending on whether the apparatus works for cooling or heating, an outdoor heat exchanger 3, an expansion valve 4, and an indoor heat exchanger 5. For a refrigeration cycle apparatus that is not required to switch between cooling and heating, flow path switching valve 2 is unnecessary.

For cooling, gaseous refrigerant of high temperature and high pressure generated through compression by compressor 1 flows through flow path switching valve 2 into outdoor heat exchanger 3 (the flow path indicated by the solid line) to be condensed at outdoor heat exchanger 3. The liquid refrigerant generated through condensation at outdoor heat exchanger 3 flows through expansion valve 4 into indoor heat exchanger 5 to be evaporated (vaporized) at indoor heat exchanger 5. Finally, the gaseous refrigerant generated through evaporation at indoor heat exchanger 5 returns to compressor 1 through flow path switching valve 2 (flow path indicated by the solid line). In this way, for cooling, the refrigerant circulates in the refrigeration circuit of the refrigeration cycle apparatus in the direction indicated by a solid line with an arrowhead shown in FIG. 1.

For heating, gaseous refrigerant of high temperature and high pressure generated through compression by compressor 1 flows through flow path switching valve 2 (the flow path indicated by the dotted line) into indoor heat exchanger 5 to be condensed at indoor heat exchanger 5. The liquid refrigerant generated through condensation at indoor heat exchanger 5 flows through expansion valve 4 into outdoor heat exchanger 3 to be is evaporated (vaporized) at outdoor heat exchanger 3. The refrigerant vaporized at outdoor heat exchanger 3 returns to compressor 1 through flow path switching valve 2 (the flow path indicated by the dotted line). In this way, for heating, the refrigerant circulates in the refrigeration circuit of the refrigeration cycle apparatus in the direction indicated by a broken line with an arrowhead shown in FIG. 1.

The above-described elements of the configuration are minimum required elements of the refrigeration cycle apparatus capable of cooling and heating. The refrigeration cycle apparatus in the present embodiment may further include other devices such as gas-liquid separator, receiver, accumulator, high-low pressure heat exchanger.

Refrigerant

Next, refrigerant to be enclosed in the refrigeration circuit in the present embodiment is described. The refrigerant contains three components: R32, HFO1123, and R1234yf falling within a predetermined composition range.

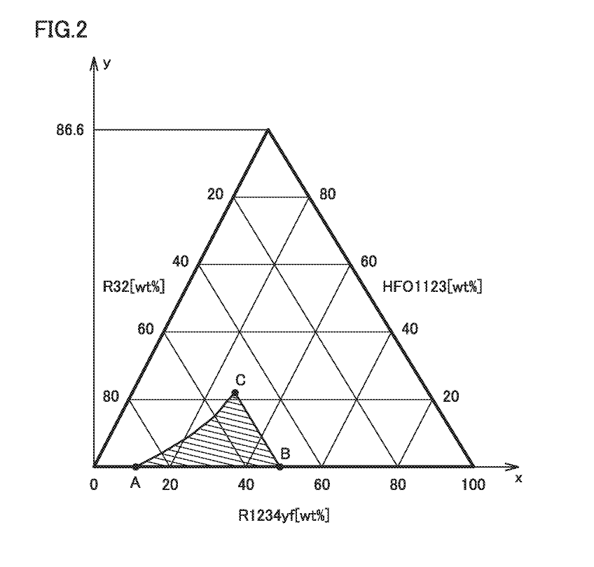

FIG. 2 is a composition diagram (ternary composition diagram) showing, by triangular coordinates, a composition ratio (mass ratio) between the three components (R32, HFO1123, and R1234yf) contained in the refrigerant. In FIG. 2, the mass ratio between the three components falls in a range (hatched portion in FIG. 2) enclosed by a first straight line connecting point A to point B, a second straight line connecting point B to point C, and a first curve connecting point C to point A. The aforementioned range includes the composition ratios on the second straight line and the first curve while it does not include the composition ratios on the first straight line.

Point A represents 89% by mass of R32, 11% by mass of R1234yf, and 0% by mass of HFO1123 (this composition ratio is represented as “R32/R1234yf/HFO1123=89/11/0% by mass” hereinafter). Point B represents the composition ratio “R32/R1234yf/HFO1123=51/49/0% by mass.” Point C represents the composition ratio “R32/R1234yf/HFO1123=51/27/22% by mass.”

The first curve connecting point C to point A is represented by the aforementioned formula (1) [boundary condition: y≥0, y≤19.1] where the first curve connects point C to point A, the x axis represents the component R1234yf, and the y axis is perpendicular to the x axis. The first curve is a line (boundary line) where the working pressure (saturation pressure at 65° C.) is equivalent to R410A.

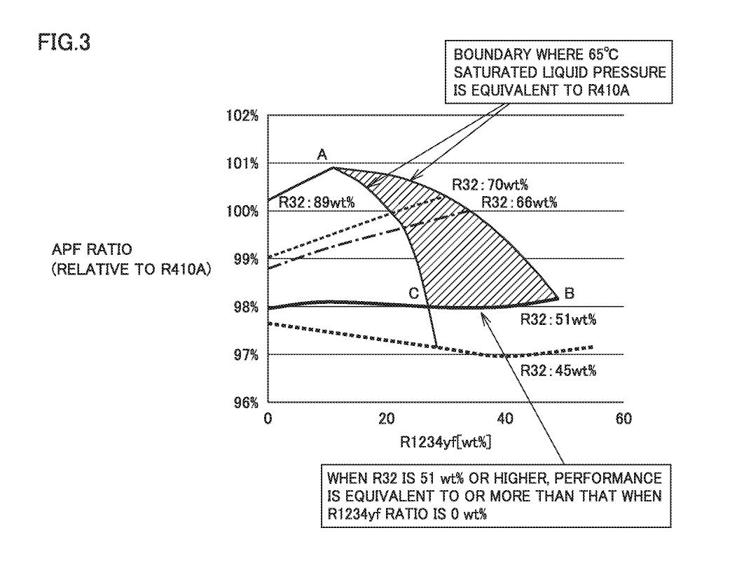

FIG. 3 is a graph showing performance exhibited in the composition range of the refrigerant according to Embodiment 1. In FIG. 3, a graph is plotted to represent a relation between the ratio of R1234yf among the three components and the APF ratio of the refrigeration cycle apparatus (ratio of the APF value to an APF value when R410A is used as a refrigerant) where the ratio of R32 among the three components is constant. The APF (Annual Performance Factor) was calculated from the results of evaluation of measurements taken under JIS C9612-2013, based on the formula: APF=(cooling seasonal total load+heating seasonal total load)/(cooling seasonal energy consumption+heating seasonal power consumption).

FIG. 3 also shows boundary lines (the curve connecting A to B and the curve connecting A to C) where the refrigerant working pressure (saturation pressure at 65° C.) is equal to that of R410A. The refrigerant saturation pressure at 65° C. was measured with a manometer. The region between the two boundary lines (between the curve connecting A to B and the curve connecting A to C) is a region where the refrigerant working pressure (saturation pressure at 65° C.) is lower than that of R410A. Outside this region, the refrigerant working pressure is higher than that of R410A.

FIG. 3 illustrates plots for respective R32 ratios: 45% by mass, 51% by mass, 66% by mass, 70% by mass, and 89% by mass. Actually, however, plots were prepared for many refrigerants with the R32 ratio ranging from 45 to 89% by mass, and fitting was performed for a boundary point of each plot where the working pressure (saturation pressure at 65° C.) is equal to that of R410A to thereby determine the aforementioned boundary lines.

In FIG. 3, the ratio of HFO1123 is a value determined by subtracting the total ratio of R32 and R1234yf from 100% by mass. Therefore, respective points on the two-axis coordinate system in FIG. 3 and the three-axis coordinate system in FIG. 2 are in a one-to-one relationship. Points A, B, and C in FIG. 3 correspond to points A, B, and C in FIG. 2, respectively. The curve connecting point A to point B in FIG. 3 corresponds to the first straight line connecting point A to point B in FIG. 2. The curve connecting point B to point C in FIG. 3 corresponds to the second straight line connecting point B to point C in FIG. 2. Further, the curve connecting point C to point A in FIG. 3 corresponds to the first curve connecting point C to point A in FIG. 2. The hatched portion in FIG. 3 therefore corresponds to the hatched portion in FIG. 2.

It is seen from FIG. 3 that when the refrigerant working pressure falls in the region where it is lower than that of R410A and the ratio of R32 among the three components falls in the range from 51% by mass to 89% by mass, the APF ratio of the refrigerant is equivalent to or higher than the APF ratio of the refrigerant in which R1234yf is 0% by mass (a two-refrigerant mixture of R32 and HFO1123). In contrast, when the ratio of R32 is less than 51% by mass (e.g., the R32 ratio is less than 45% by mass represented by the lowest plot in FIG. 3), the APF ratio of the refrigerant is lower than the APF ratio where R1234yf is 0% by mass.

As seen from the above, when the refrigerant composition ratio falls in the hatched portion in FIG. 3 (i.e., the hatched portion in FIG. 2), the refrigerant working pressure is lower than that of the conventional refrigerant (R410A), and the performance equivalent to or higher than that of the two-refrigerant mixture of R32 and HFO1123 is achieved.

Thus, the working pressure of the refrigerant lower than the working pressure of R410A enables the reliability to be maintained or improved in terms of the resistance to pressure of the refrigeration cycle apparatus. For example, even when the above-described refrigerant is used instead of R410A in an existing refrigeration cycle apparatus for air conditioning in which R410A has been used (e.g., heat-pump-type refrigeration cycle apparatus), the reliability of the refrigeration cycle apparatus can be maintained in terms of the resistance to pressure.

Moreover, when the refrigerant composition falls in the range indicated by the hatched portion in FIG. 2, the GWP of the refrigerant is reduced by 71% to 83% relative to the GWP (2090) of R410A. The GWP of R1234yf is 4. The refrigeration cycle apparatus of the present embodiment therefore has low influence on global warming.

As seen from the foregoing, the refrigeration cycle apparatus of the present embodiment uses the refrigerant having the specific composition, and therefore has low influence on global warming, has sufficient reliability, and has sufficient performance (equivalent to or more than that of the two-refrigerant mixture of R32 and HFO1123).

The ratio of R1234yf having a relatively low working pressure can be increased to reduce the temperature of refrigerant discharged from the compressor, as compared with the refrigerant mixture of R32 and HFO1123. In this way, the reliability of the compressor in terms of heat resistance can be improved.

Moreover, the low refrigerant working pressure enables increase of the condensation temperature at high outside air temperature to thereby enable improvement of the refrigeration capacity. Specifically, in the case where a pressure at which the reliability can be ensured is an upper limit, decrease of the refrigerant working pressure causes increase of the condensation temperature. As the condensation temperature increases and accordingly the temperature difference between the condensation temperature and the high outside air temperature increases, the refrigeration capacity is improved.

The refrigerant used for the present embodiment may be a three-refrigerant mixture consisting of the above-described three components only, or may contain additional component(s). The additional component may for example be R290, R1270. R134a, R125, or other HFC. The content of the additional component is set within a range that does not hinder the main advantages of the present embodiment.

The refrigerant may further contain refrigeration oil. The refrigeration oil may for example be a commonly-used refrigeration oil (such as ester-based lubricating oil, ether-based lubricating oil, fluorine-based lubricating oil, mineral-based lubricating oil, hydrocarbon-based lubricating oil). In this case, preferably a refrigeration oil excellent in compatibility with refrigerant and stability for example is selected.

The refrigerant may further contain a stabilizer as required, in the case for example where high stability is required under harsh conditions in use, for example. The stabilizer is a component for improving the stability of refrigerant against heat and oxidation. The stabilizer may for example be any known stabilizer used conventionally for refrigeration cycle apparatuses, such as oxidation resistance improving agent, heat resistance improving agent, metal deactivator, or the like.

The refrigerant may further contain polymerization inhibitor. The polymerization inhibitor may for example be hydroquinone, hydroquinone methyl ether, or benzotriazole.

Refrigeration Cycle Apparatus

Preferably, the refrigeration cycle apparatus of the present embodiment is a refrigeration cycle apparatus for air conditioning (air conditioner). R410A is a refrigerant having been used chiefly for the air conditioner. The refrigerant used for the refrigeration cycle apparatus of the present embodiment has a working pressure lower than the working pressure of R410A. Thus, particularly for the refrigeration cycle apparatus for air conditioning, the reliability can be maintained in terms of the resistance to pressure.

The refrigeration cycle apparatuses for air conditioning (air conditioner) may for example be room air conditioner, package air conditioner, multi air conditioner for building, window-type air conditioner, and mobile air conditioner.

For the refrigeration cycle apparatus for air conditioning, preferably the refrigerant flow direction with respect to the air flow direction is set so that the seasonal performance factor in consideration of the total performance factor in a certain period, such as APF (annual performance factor), is maximized. In this way, the actual performance factor (performance) of the refrigeration cycle apparatus used for air conditioning can be improved. Specifically, a description is given below of a method for setting the refrigerant flow direction with respect to the air flow direction so that the seasonal performance factor is maximized.

In the case where the refrigerant flow direction is opposite to the air flow direction (a refrigerant flow in such a direction is referred to as “counterflow” hereinafter), relatively higher performance is achieved as compared with the case where the refrigerant flow direction is the same as the air flow direction (a refrigerant flow in such a direction is referred to as “parallel flow” hereinafter). The seasonal performance factor of the refrigeration cycle apparatus can be increased by setting the refrigerant flow direction with respect to the air flow direction so that the refrigerant flow through a portion used for a relatively longer period in a certain period and having a largest heat exchange amount is a counterflow. In this way, the seasonal performance factor of the refrigeration cycle apparatus can be increased.

Thus, in the case of an air conditioner used chiefly for cooling (such as multi air conditioner for building), the outdoor heat exchanger (evaporator) has the largest heat exchange amount. In order to maximize the seasonal performance factor, it is preferable to design the air conditioner so that the refrigerant flow through the outdoor heat exchanger (evaporator) is counterflow and the refrigerant flow through the indoor heat exchanger (condenser) is parallel flow.

In the case of an air conditioner used chiefly for heating (such as room air conditioner, package air conditioner), the indoor heat exchanger (condensation) has the largest heat exchange amount. In order to maximize the seasonal performance factor, it is preferable to design the air conditioner so that the refrigerant flow through the outdoor heat exchanger (evaporation) is parallel flow and the refrigerant flow through the indoor heat exchanger (condensation) is counterflow.

In the case of a reversible air conditioner capable of both cooling and heating (such as room air conditioner), the annual energy consumption of heating is generally considered higher than that of cooling. Because of this, the APF for heating of higher annual energy consumption is set to a larger value. In the case where the energy consumption of heating is higher than that of cooling and the seasonal performance factor is to be maximized, preferably the air conditioner is designed so that the refrigerant flow through the outdoor heat exchanger (evaporation) is parallel flow and the refrigerant flow through the indoor heat exchanger (condensation) is counterflow, like the air conditioner used chiefly for heating.

In the case where the energy consumption of cooling is higher than that of heating in a given period, preferably the air conditioner is designed so that the refrigerant flow through the outdoor heat exchanger (evaporator) is counterflow and the refrigerant flow through the indoor heat exchanger (condenser) is parallel flow, like the air conditioner used chiefly for cooling.

Patent Document 3 (WO2015/115550) does not specifically describe a refrigeration cycle apparatus switched between cooling and heating (such as room air conditioner, for example) and does not take the seasonal performance factor into consideration.

The above-described design is a design combining Lorentz cycle, hexagonal valve and the like so that one of the outdoor heat exchanger and the indoor heat exchanger has counterflow in both the cooling mode and the heating mode (cycle in which one of outdoor and indoor is counterflow).

Alternatively, the Lorentz cycle and a multi-way valve such as hexagonal valve and the like may be combined so that both the outdoor heat exchanger and the indoor heat exchanger have counterflow in both the cooling mode and the heating mode (cycle in which both the outdoor and the indoor are counterflow).

A design may be made to combine a check valve, three-way valve and the like so that one of or both the outdoor heat exchanger and the indoor heat exchanger partially or entirely have counterflow all the time in the cooling and heating modes, for example (partially counterflow: partial counterflow cycle, entirely counterflow: all counterflow cycle).

### Modification of Embodiment 1

The present modification differs from Embodiment 1 in that the composition of refrigerant is further limited within the range of Embodiment 1. In other respects, the basic configuration is the same as that of Embodiment 1, and the description of the same configuration is not repeated. According to the present modification, the refrigerant working pressure is lower than that of the conventional refrigerant, and additionally the performance equivalent to or higher than the performance of R410A (higher than Embodiment 1) can be obtained.

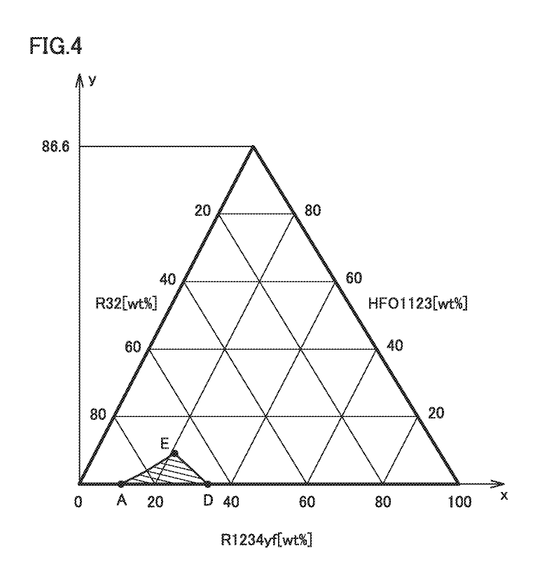

FIG. 4 is a ternary composition diagram showing a composition ratio between the three components (R32, HFO1123, and R1234yf) contained in the refrigerant in the present modification. In FIG. 4, the mass ratio between the three components falls in a range (hatched portion in FIG. 4) enclosed by a third straight line connecting point A to point D, a fourth straight line connecting point D to point E, and a second curve connecting point E to point A. The aforementioned range includes the composition ratios on the fourth straight line and the second curve while it does not include the composition ratios on the third straight line.

Point A represents the composition ratio “R32/R1234yf/HFO1123=89/11/0% by mass” (similarly to FIG. 2). Point D represents the composition ratio “R32/R1234yf/HFO1123=66/34/0% by mass.” Point E represents the composition ratio “R32/R1234yf/HFO1123=70/21/9% by mass.”

The second curve connecting point E to point A is represented by the aforementioned formula (1) [boundary condition: y≥0, y≤7.8] where the x axis represents the component R1234yf, and the y axis is perpendicular to the x axis. The second curve is a line (boundary line) where the working pressure (saturation pressure at 65° C.) is equivalent to R410A.

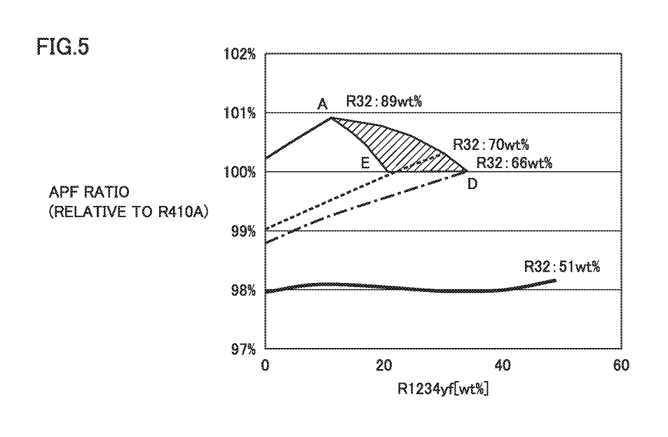

FIG. 5 is a graph showing performance exhibited in the composition range of the refrigerant according to the present modification. The description of the graph is similar to that for FIG. 3 and is therefore not repeated.

It is seen from FIG. 5 that when the refrigerant composition ratio falls in the hatched portion in FIG. 5 (i.e., the hatched portion in FIG. 4), the refrigerant working pressure is lower than that of the conventional refrigerant (R410A), like the first embodiment. It is also seen that because the APF ratio (relative to R410A) is 100/0% or higher, the performance equivalent to or higher than the performance of R410A is achieved.

When the refrigerant composition falls in the range indicated by the hatched portion in FIG. 4, the GWP of the refrigerant is reduced by 71% to 79% relative to the GWP of R410A.

Accordingly, the refrigeration cycle apparatus of the present modification has low influence on global warming, has sufficient reliability, and has sufficient performance (equivalent to or more than R410A).

### Embodiment 2

The present embodiment differs from Embodiment 1 in that the former uses R1234ze instead of R1234yf as one of three components of refrigerant. In other respects, the basic configuration is the same as that of Embodiment 1, and the description of the same configuration is not repeated.

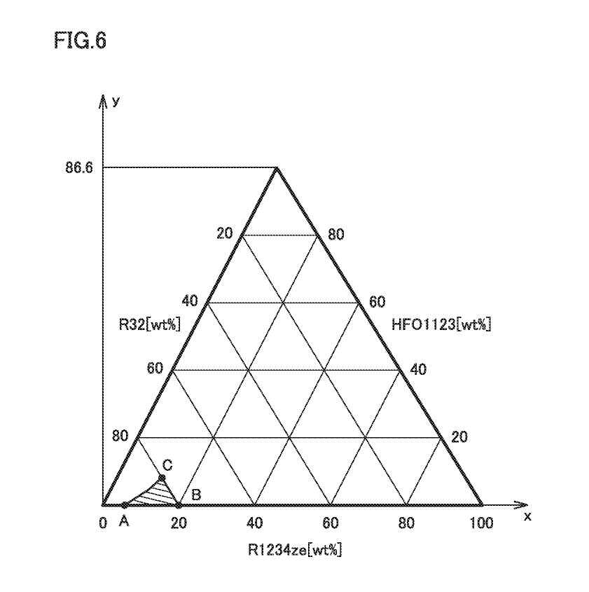

FIG. 6 is a ternary composition diagram showing a composition ratio between the three components (R32, HFO1123, and R1234ze) contained in the refrigerant in the present embodiment. In FIG. 6, the mass ratio between the three components falls in a range (hatched portion in FIG. 6) enclosed by a first straight line connecting point A to point B, a second straight line connecting point B to point C, and a first curve connecting point C to point A. The aforementioned range includes the composition ratios on the second straight line and the first curve while it does not include the composition ratios on the first straight line.

Point A represents the composition ratio “R32/R1234ze/HFO1123=94/6/0/by mass.” Point B represents the composition ratio “R32/R1234ze/HFO1123=80/20/0% by mass.” Point C represents the composition ratio “R32/R1234ze/HFO1123=80/12/8% by mass.”

The first curve connecting point C to point A is represented by the aforementioned formula (2) [boundary condition: y≥0, y≤6.93] where the x axis represents the component R1234ze and the y axis is perpendicular to the x axis. The first curve is a line (boundary line) where the working pressure (saturation pressure at 65° C.) is equivalent to R410A.

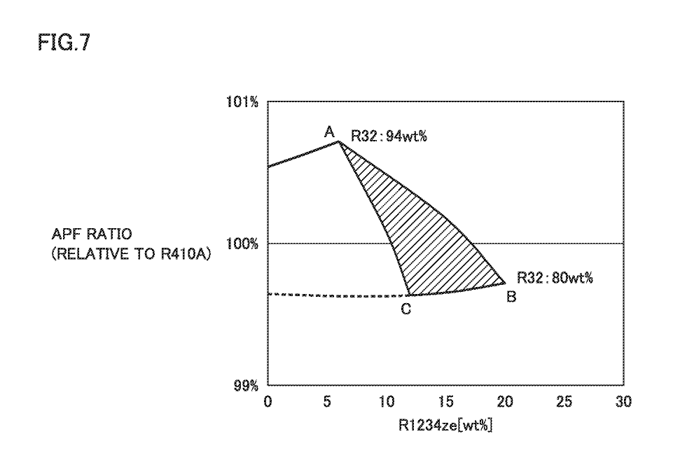

FIG. 7 is a graph showing performance exhibited in the composition range of the refrigerant according to the present embodiment. The description of the graph is similar to that for FIG. 3 and is therefore not repeated.

It is seen from FIG. 7 that when the refrigerant composition ratio falls in the hatched portion in FIG. 7 (i.e., the hatched portion in FIG. 6), the refrigerant working pressure is lower than that of the conventional refrigerant (R410A), and the performance equivalent to or higher than the performance of a two-refrigerant mixture of R32 and HFO1123 is achieved.

When the refrigerant composition falls in the range indicated by the hatched portion in FIG. 6, the GWP of the refrigerant is reduced by 70% to 74% relative to the GWP of R410A. The GWP of R1234ze is 6.

As seen from the foregoing, the refrigeration cycle apparatus of the present embodiment uses the refrigerant having the specific composition, and therefore has low influence on global warming, has sufficient reliability, and has sufficient performance (equivalent to or more than that of the two-refrigerant mixture of R32 and HFO1123).

The ratio of R1234ze having a relatively low working pressure can be increased to lower the temperature of refrigerant discharged from the compressor, relative to the refrigerant mixture of R32 and HFO1123. In this way, the reliability of the compressor can be enhanced.

Moreover, the increase of the ratio of R1234ze having a relatively low working pressure causes decrease of the refrigerant working pressure, which enables increase of the condensation temperature at high outside air temperature to thereby enable improvement of the refrigeration capacity. Specifically, in the case where a pressure at which the reliability can be ensured is an upper limit, decrease of the refrigerant working pressure causes increase of the condensation temperature. As the condensation temperature increases and accordingly the temperature difference between the condensation temperature and the high outside air temperature increases, the refrigeration capacity is improved.

### Modification of Embodiment 2

The present modification differs from Embodiment 2 in that the composition of refrigerant is further limited within the range of Embodiment 2. In other respects, the basic configuration is the same as that of Embodiment 2, and the description of the same configuration is not repeated. According to the present modification, the refrigerant working pressure is lower than that of the conventional refrigerant, and additionally the performance equivalent to or higher than the performance of R410A (performance higher than Embodiment 2) can be obtained.

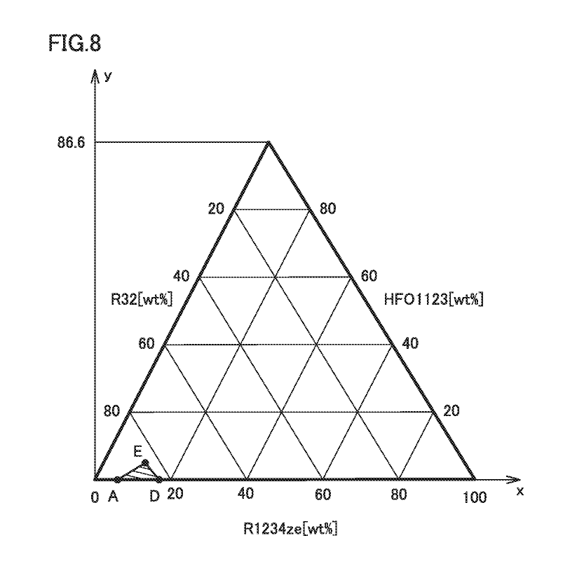

FIG. 8 is a ternary composition diagram showing a composition ratio between the three components (R32, HFO1123, and R1234ze) contained in the refrigerant in the present modification. In FIG. 8, the mass ratio between the three components falls in a range (hatched portion in FIG. 8) enclosed by a third straight line connecting point A to point D, a fourth straight line connecting point D to point E, and a second curve connecting point E to point A. The aforementioned range includes the composition ratios on the fourth straight line and the second curve while it does not include the composition ratios on the third straight line.

Point A represents the composition ratio “R32/R1234ze/HFO1123=94/6/0% by mass” (similarly to FIG. 6). Point D represents the composition ratio “R32/R1234ze/HFO1123=83/17/0% by mass.” Point E represents the composition ratio “R32/R1234ze/HFO1123=84/11/5% by mass.”

The second curve connecting point E to point A is represented by the aforementioned formula (2) [boundary condition y≥0, y≤4.33] where the x axis represents the component R1234ze, and the y axis is perpendicular to the x axis. The second curve is a line (boundary line) where the working pressure (saturation pressure at 65° C.) is equivalent to R410A.

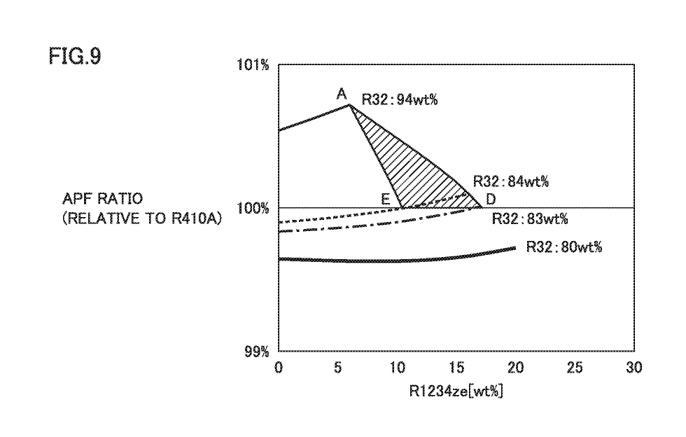

FIG. 9 is a graph showing performance exhibited in the composition range of the refrigerant according to the present modification. The description of the graph is similar to that for FIG. 3 and is therefore not repeated.

It is seen from FIG. 9 that when the refrigerant composition ratio falls in the hatched portion in FIG. 9 (i.e., the hatched portion in FIG. 8), the refrigerant working pressure is lower than that of the conventional refrigerant (R410A), like the second embodiment. It is also seen that because the APF ratio is 100% or higher, the performance equivalent to or higher than the performance of R410A is achieved.

When the refrigerant composition falls in the range indicated by the hatched portion in FIG. 8, the GWP of the refrigerant is reduced by 70% to 73% relative to the GWP of R410A.

Accordingly, the refrigeration cycle apparatus of the present modification has low influence on global warming, has sufficient reliability, and has sufficient performance (equivalent to or more than R410A).

### Embodiment 3

Refrigerant

A refrigeration cycle apparatus according to the present embodiment differs from Embodiment 1 in that the composition ratio between three components contained in refrigerant is set so that the refrigerant working pressure is lower than that of a conventional refrigerant (R404A) different from that in Embodiment 1. In other respects, the basic configuration is the same as that of Embodiment 1, and the description of the same configuration is not repeated.

R404A is a pseudo-azeotropic refrigerant mixture of pentafluoroethane (R125), 1,1,1-trifluoroethane (R143a) and 1,1,1,2-tetrafluoroethane (R134a).

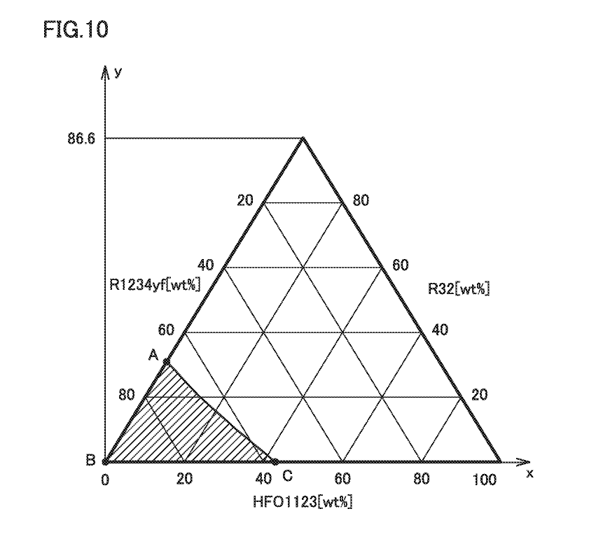

FIG. 10 is a ternary composition diagram showing a composition ratio between the three components (R32, HFO1123, and R1234yf) contained in the refrigerant of the present embodiment. In FIG. 10, the mass ratio between the three components falls in a range (hatched portion in FIG. 10) enclosed by a first straight line connecting point A to point B, a second straight line connecting point B to point C, and a first curve connecting point C to point A. The aforementioned range includes the composition ratios on the first curve while it does not include the composition ratios on the first straight line and the second straight line.

Point B represents the composition ratio “R32/R1234yf/HFO1123=0/100/0% by mass.” Point C represents the composition ratio “R32/R1234yf/HFO1123=0/57/43% by mass.” Point A represents the composition ratio “R32/R1234yf/HFO123=31/69/0% by mass.”

The first curve connecting point C to point A is represented by the aforementioned formula (3) [boundary condition: y≥0, y≤26.7] where the x axis represents the component HFO1123, and the y axis is perpendicular to the x axis. The first curve is a line (boundary line) where the working pressure (saturation pressure at 65° C.) is equivalent to R404A.

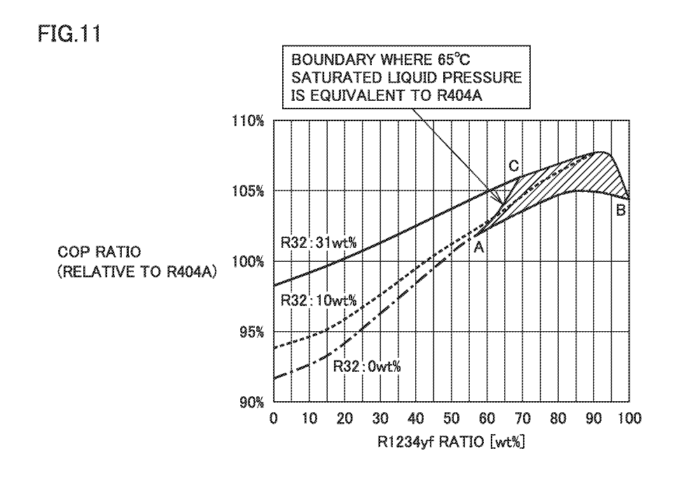

FIG. 11 is a graph showing performance exhibited in the composition range of the refrigerant according to the present embodiment. FIG. 11 is the graph for a refrigerator. The refrigerator does not switch between cooling and heating. Therefore, regarding the performance, the energy consumption efficiency (Coefficient of Performance: COP) was measured, rather than the seasonal performance factor (such as APF).

The COP can be determined from respective values of evaporation capacity and power consumption, using formula: cooling COP=evaporation capacity (kW)/power consumption (kW). In other respects, the graph is similar to FIG. 3, and the description is not repeated.

It is seen from FIG. 11 that when the refrigerant composition ratio falls in the hatched portion in FIG. 11 (i.e., hatched portion in FIG. 10), the refrigerant working pressure is lower than that of the conventional refrigerant (R404A) and the performance equivalent to or higher than that of a two-refrigerant mixture of R32 and HFO1123 (and R404A) is achieved.

Moreover, when the refrigerant composition falls in the range of the hatched portion in FIG. 10, the GWP of the refrigerant is lower than the GWP (3920) of R404A by 90% to 100%. The GWP of R1234yf is 6.

As seen from the foregoing, the refrigeration cycle apparatus of the present embodiment uses the refrigerant having the specific composition, and therefore has low influence on global warming, has sufficient reliability, and has sufficient performance (equivalent to or more than the two-refrigerant mixture of R32 and HFO1123).

Refrigeration Cycle Apparatus

The refrigeration cycle apparatus of the present embodiment is preferably a refrigeration cycle apparatus for refrigeration (refrigerator). R404A has been used chiefly for the refrigerator. The refrigerant used for the refrigeration cycle apparatus of the present embodiment has a lower working pressure than the working pressure of R404A. Therefore, the reliability in terms of resistance to pressure can be maintained particularly in the refrigeration cycle apparatus for the refrigerator.

The refrigeration cycle apparatus for refrigeration (refrigerator) may for example be refrigerating chamber, water cooler, ice maker, turbo refrigerator, chiller (chilling unit), screw type refrigerator, freezing and refrigerating unit, refrigerator display case, freezer display case, vending machine, or the like.

An example of the operation of the refrigeration cycle apparatus in the present embodiment is described. Since the refrigeration cycle apparatus (refrigerator) in the present embodiment does not switch between cooling and heating, no flow path switching valve 2 is necessary. Therefore, the refrigeration cycle apparatus in the present embodiment differs from the refrigeration cycle apparatus shown in FIG. 1 in that the former is not equipped with flow path switching valve 2 used for changing the refrigerant circulating direction, and that and the refrigerant circulates through the flow path indicated by the solid line in FIG. 1.

Referring to FIG. 1 (except for flow path switching valve 2), gaseous refrigerant of high temperature and high pressure generated through compression by compressor 1 flows into outdoor heat exchanger (condenser) 3 where it is condensed. The liquid refrigerant generated through condensation at outdoor heat exchanger 3 flows through expansion valve 4 into indoor heat exchanger (evaporator) 5 where the liquid refrigerant is evaporated (vaporized). Finally, the gaseous refrigerant generated through evaporation at indoor heat exchanger 5 returns to compressor 1.

The refrigerator does not switch between cooling and heating, and is therefore preferably designed so that the refrigerant flow direction with respect to the air flow direction is counterflow at both the indoor heat exchanger and the outdoor heat exchanger (condenser and evaporator).

### Embodiment 4

The present embodiment differs from Embodiment 3 in that the former uses R1234ze instead of R1234yf among the three components of refrigerant. In other respects, the basic configuration is the same as that of Embodiment 3, and the description of the same configuration is not repeated.

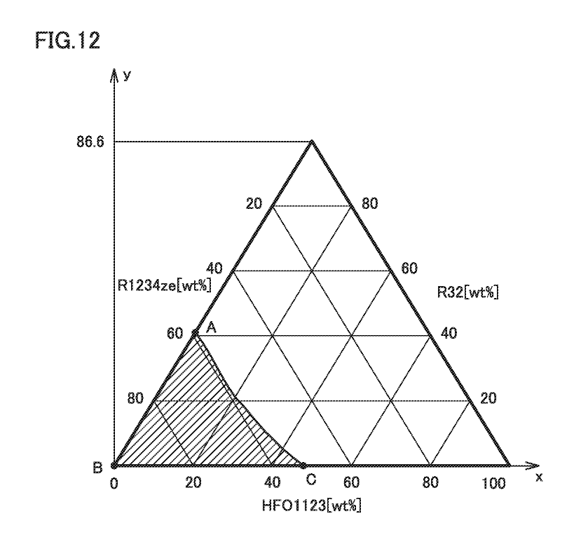

FIG. 12 is a ternary composition diagram showing a composition ratio between the three components (R32, HFO1123, and R1234ze) contained in the refrigerant in the present embodiment. In FIG. 12, the mass ratio between the three components falls in a range (hatched portion in FIG. 12) enclosed by a first straight line connecting point A to point B, a second straight line connecting point B to point C, and a first curve connecting point C to point A. The aforementioned range includes the composition ratios on the first curve while it does not include the composition ratios on the first straight line and the second straight line.

Point A represents the composition ratio “R32/R1234ze/HFO1123=0/52/48% by mass.” Point B represents the composition ratio “R32/R1234ze/HFO1123=0/100/0% by mass.” Point C represents the composition ratio “R32/R1234ze/HFO1123=41/59/0% by mass.”

The first curve connecting point C to point A is represented by the aforementioned formula (4) [boundary condition y≥0, y≤35.3] where the x axis represents the component HFO1123, and the y axis is perpendicular to the x axis. The first curve is a line (boundary line) where the working pressure (saturation pressure at 65° C.) is equivalent to R404A.

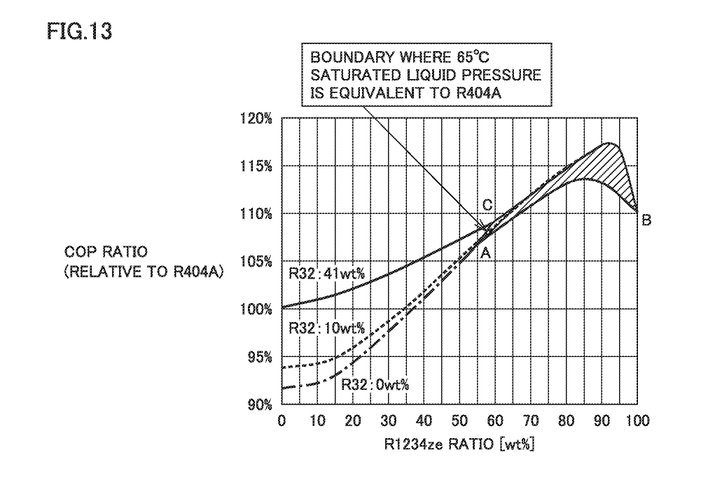

FIG. 13 is a graph showing performance exhibited in the composition range of the refrigerant according to the present embodiment. The description of the graph is similar to that for FIG. 11 and is therefore not repeated.

It is seen from FIG. 13 that when the refrigerant composition ratio falls in the hatched portion in FIG. 13 (i.e., the hatched portion in FIG. 12), the refrigerant working pressure is lower than that of the conventional refrigerant (R404A), and the performance equivalent to or higher than the performance of a two-refrigerant mixture of R32 and HFO1123 (and R404A) is achieved.

When the refrigerant composition falls in the range indicated by the hatched portion in FIG. 12, the GWP of the refrigerant is reduced by 86% to 100% relative to the GWP of R404A.

As seen from the foregoing, the refrigeration cycle apparatus of the present embodiment uses the refrigerant having the specific composition, and therefore has low influence on global warming, has sufficient reliability, and has sufficient performance (equivalent to or more than that of the two-refrigerant mixture of R32 and HFO1123).

### REFERENCE SIGNS LIST

1 compressor; 2 flow path switching valve; 3 outdoor heat exchanger; 4 expansion valve; 5 indoor heat exchanger

1. A refrigeration cycle apparatus comprising a refrigeration circuit,
the refrigeration circuit comprising a compressor, an outdoor heat exchanger, an indoor heat exchanger, and an expansion valve,
refrigerant being enclosed in the refrigeration circuit,
the refrigerant containing three components that are R32, R1234yf, and HFO1123,
in a composition diagram in which a mass ratio between the three components is represented by triangular coordinates, the mass ratio between the three components falling in a range enclosed by
a first straight line connecting a point A to a point B, the point A representing 89% by mass of R32, 11% by mass of R1234yf, and 0% by mass of HFO1123, and the point B representing 51% by mass of R32, 49% by mass of R1234yf, and 0% by mass of HFO1123,
a second straight line connecting the point B to a point C, the point C representing 51% by mass of R32, 27% by mass of R1234yf, and 22% by mass of HFO1123, and a first curve connecting the point C to the point A and represented by a formula (1):
y=0.0000268168x⁴−0.0021756190x³+0.0709089095x²−0.5115229095x−0.4473576993 (1)
where an x axis represents the component R1234yf, a y axis is perpendicular to the x axis, and a boundary condition is y≥0, y≤19.1,
all the three components each having a mass ratio of more than 0% by mass,
wherein the refrigeration cycle apparatus is used for refrigeration.

2. The refrigeration cycle apparatus according to claim 1, wherein
in a composition diagram in which the mass ratio between the three components is represented by triangular coordinates, the mass ratio between the three components falls in a range enclosed by
a third straight line connecting the point A to a point D, the point D representing 66% by mass of R32, 34% by mass of R1234yf, and 0% by mass of HFO1123,
a fourth straight line connecting the point D to a point E, the point E representing 70% by mass of R32, 21% by mass of R1234yf, and 9% by mass of HFO1123, and
a second curve connecting the point E to the point A and represented by the formula (1) where the x axis represents the component R1234yf, the y axis is perpendicular to the x axis, and a boundary condition is y≥0, y≤7.8.

3. A refrigeration cycle apparatus comprising a refrigeration circuit, the refrigeration circuit comprising a compressor, an outdoor heat exchanger, an indoor heat exchanger, and an expansion valve,
refrigerant being enclosed in the refrigeration circuit,
the refrigerant containing three components that are R32, R1234ze, and HFO1123, in a composition diagram in which a mass ratio between the three components is represented by triangular coordinates, the mass ratio between the three components falling in a range enclosed by
a first straight line connecting a point A to a point B, the point A representing 94% by mass of R32, 6% by mass of R1234ze, and 0% by mass of HFO1123, and the point B representing 80% by mass of R32, 20% by mass of R1234ze, and 0% by mass of HFO1123, a second straight line connecting the point B to a point C, the point C representing 80% by mass of R32, 12% by mass of R1234ze, and 8% by mass of HFO1123, and
a first curve connecting the point C to the point A and represented by a formula (2):
y=0.0076x²+0.5253x−3.4259 (2)
where an x axis represents the component R1234ze, a y axis is perpendicular to the x axis, and a boundary condition is y≥0, y≤6.93,
all the three components each having a mass ratio of more than 0% by mass.

4. The refrigeration cycle apparatus according to claim 3, wherein
in a composition diagram in which the mass ratio between the three components is represented by triangular coordinates, the mass ratio between the three components falls in a range enclosed by
a third straight line connecting the point A to a point D, the point D representing 83% by mass of R32, 17% by mass of R1234ze, and 0% by mass of HFO1123,
a fourth straight line connecting the point D to a point E, the point E representing 84% by mass of R32, 11% by mass of R1234ze, and 5% by mass of HFO1123, and
a second curve connecting the point E to the point A and represented by the formula (2) where the x axis represents the component R1234ze, the y axis is perpendicular to the x axis, and a boundary condition is y≥0, y≤4.33.

5. (canceled)

6. The refrigeration cycle apparatus according to claim 1, wherein
the refrigeration cycle apparatus is a multi air conditioner for building,
the refrigeration cycle apparatus further comprises a flow path switching valve to switch between a first operation in which the outdoor heat exchanger serves as an evaporator and the indoor heat exchanger serves as a condenser, and a second operation in which the outdoor heat exchanger serves as a condenser and the indoor heat exchanger serves as an evaporator, and
in the outdoor heat exchanger in the first operation, flow of the refrigerant with respect to air flow is counterflow.

7. The refrigeration cycle apparatus according to claim 1, wherein
the refrigeration cycle apparatus is a room air conditioner or package air conditioner,
the refrigeration cycle apparatus further comprises a flow path switching valve to switch between a first operation in which the outdoor heat exchanger serves as an evaporator and the indoor heat exchanger serves as a condenser, and a second operation in which the outdoor heat exchanger serves as a condenser and the indoor heat exchanger serves as an evaporator, and
in the indoor heat exchanger in the first operation, flow of the refrigerant with respect to air flow is counterflow.

8. A refrigeration cycle apparatus comprising a refrigeration circuit, the refrigeration circuit comprising a compressor, an outdoor heat exchanger, an indoor heat exchanger, and an expansion valve,
refrigerant being enclosed in the refrigeration circuit,
the refrigerant containing three components that are R32, R1234yf, and HFO1123,
in a composition diagram in which a mass ratio between the three components is represented by triangular coordinates, the mass ratio between the three components falling in a range enclosed by
a first straight line connecting a point B to a point C, the point B representing 0% by mass of R32, 100% by mass of R1234yf, and 0% by mass of HFO1123, and the point C representing 0% by mass of R32, 57% by mass of R1234yf, and 43% by mass of HFO1123,
a second straight line connecting the point B to a point A, the point A representing 31% by mass of R32, 69% by mass of R1234yf, and 0% by mass of HFO1123, and
a curve connecting the point C to the point A and represented by a formula (3):
y=−0.0002x³+0.0284x²−1.9477x+50.834 (3)
where an x axis represents the component HFO1123, a y axis is perpendicular to the x axis, and a boundary condition is y≥0, y≤26.7,
all the three components each having a mass ratio of more than 0% by mass.

9. A refrigeration cycle apparatus comprising a refrigeration circuit, the refrigeration circuit comprising a compressor, an outdoor heat exchanger, an indoor heat exchanger, and an expansion valve,
refrigerant being enclosed in the refrigeration circuit,
the refrigerant containing three components that are R32, R1234ze, and HFO1123,
in a composition diagram in which a mass ratio between the three components is represented by triangular coordinates, the mass ratio between the three components falling in a range enclosed by
a first straight line connecting a point B to a point C, the point B representing 0% by mass of R32, 100% by mass of R1234ze, and 0% by mass of HFO1123, and the point C representing 0% by mass of R32, 52% by mass of R1234ze, and 48% by mass of HFO1123,
a second straight line connecting the point B to a point A, the point A representing 41% by mass of R32, 59% by mass of R1234ze, and 0% by mass of HFO1123, and
a curve connecting the point C to the point A and represented by a formula (4):
y=2.16319E⁻⁰⁵x⁴−3.47400E⁻⁰³x³+2.21550E⁻⁰¹x²−7.61233E⁺⁰⁰x+1.24171E⁺² (4)
where an x axis represents the component HFO1123, a y axis is perpendicular to the x axis, and a boundary condition is y≥0, y≤35.3,
all the three components each having a mass ratio of more than 0% by mass.

10. The refrigeration cycle apparatus according to claim 8, wherein the refrigeration cycle apparatus is used for refrigeration.

11. A refrigeration cycle apparatus comprising a refrigeration circuit, the refrigeration circuit comprising a compressor, an outdoor heat exchanger, an indoor heat exchanger, and an expansion valve,
refrigerant being enclosed in the refrigeration circuit,
the refrigerant containing three components that are R32, R1234yf, and HFO1123,
in a composition diagram in which a mass ratio between the three components is represented by triangular coordinates, the mass ratio between the three components falling in a range enclosed by
a first straight line connecting a point A to a point B, the point A representing 89% by mass of R32, 11% by mass of R1234yf, and 0% by mass of HFO1123, and the point B representing 51% by mass of R32, 49% by mass of R1234yf, and 0% by mass of HFO1123, a second straight line connecting the point B to a point C, the point C representing 51% by mass of R32, 27% by mass of R1234yf, and 22% by mass of HFO1123, and
a first curve connecting the point C to the point A and represented by a formula (1):
y=0.0000268168x⁴−0.0021756190x³+0.0709089095x²−0.5115229095x−0.4473576993 (1)
where an x axis represents the component R1234yf, a y axis is perpendicular to the x axis, and a boundary condition is y≥0, y≤19.1,
all the three components each having a mass ratio of more than 0% by mass,
wherein R410A has been used in the refrigeration cycle apparatus.

12. The refrigeration cycle apparatus according to claim 11, wherein
in a composition diagram in which the mass ratio between the three components is represented by triangular coordinates, the mass ratio between the three components falls in a range enclosed by
a third straight line connecting the point A to a point D, the point D representing 66% by mass of R32, 34% by mass of R1234yf, and 0% by mass of HFO1123,
a fourth straight line connecting the point D to a point E, the point E representing 70% by mass of R32, 21% by mass of R1234yf, and 9% by mass of HFO1123, and
a second curve connecting the point E to the point A and represented by the formula (1) where the x axis represents the component R1234yf, the y axis is perpendicular to the x axis, and a boundary condition is y≥0, y≤7.8.

13. The refrigeration cycle apparatus according to claim 9, wherein the refrigeration cycle apparatus is used for refrigeration.
